(19) United States
(12) Patent Application Publication
(10) Pub. No.: US 2021/0204741 A1
(43) Pub. Date: Jul. 8, 2021

(54) SELF-HEATING CONTAINER FOR FOOD

(71) Applicants: Roberto Burroni, Arezzo (AR) (IT); Mario Mancini, Poppi (AR) (IT)

(72) Inventors: Roberto Burroni, Arezzo (AR) (IT); Mario Mancini, Poppi (AR) (IT)

(21) Appl. No.: 17/057,208

(22) PCT Filed: May 17, 2019
(86) PCT No.: PCT/IT2019/050105

§ 371 Date: Nov. 20, 2020

(30) Foreign Application Priority Data
May 23, 2018 (IT) 102018000005630

(51) Int. Cl. A47J 27/00; A47J 36/24

(52) U.S. Cl. CPC A47J 27/004; A47J 36/2433; A47J 36/2472

(57) ABSTRACT

A container made from an electrically insulating material whose walls are functionally connected to a temperature sensor and incorporate heating groups consisting of a plurality of elongate metal elements; should the container be made from glass, the coefficient of thermal expansion of the heating groups is similar to that of glass. The container is functionally associated with an electronic power and control module, connected to the heating groups and comprising a rechargeable energy accumulator of a type with one or several high-performance cells. The metal elements are heated by Joule effect by the flow of a pulsed current provided by the energy accumulator and controlled by the electronic power and control module.

### TECHNICAL FIELD

The present invention belongs to the sector of food containers, in particular to the sector of transportable and re-usable containers.

More specifically, the invention belongs to the sector of containers capable of autonomously heating their own contents, without being in need of external power sources.

As a matter of fact, the self-heating container according to the present patent application is specifically conceived for being used without being connected to external electric power sources.

### PRESENT STATUS OF THE ART

Different types of self-heating food containers are known, the most popular of which incorporate heating elements of different kinds, but they need an external power source for being heated; for example, an induction heating plate accommodated in the base and connected to an external power source, along with a temperature control unit and a display for displaying the heating temperature.

Self-heating containers are also known which do not need any connection to the mains because they comprise even rechargeable energy accumulators often associated with: a control unit for monitoring a number of parameters, including the temperature measured by a dedicated sensor, a power unit comprising a removable electrical device, and a display for displaying information.

The proposed solutions have a number of disadvantages, mainly related to the weight and space occupation of the container, both of which are rather high if compared to the volume available for food, as well as to the reduced duration of energy accumulators.

Also, the subject devices being highly complicated make it difficult to clean and sterilize them.

In particular, patent document U.S. Pat. No. 5,208,896 A discloses a baby bottle wherein the contents are held at the mother's milk temperature thanks to a rechargeable battery which supplies power to resistors incorporated in the walls of the container. This solution is a very rough one, with a control of an on/off type operated by a thermostat which opens the heating circuit whenever the temperature reaches a maximum value and closes it again whenever it drops below a minimum value, without any possibility of varying the temperature values and without making it possible to modulate the power that is transferred from the battery to the heating elements, hence to the contents of the baby bottle, whereby it is not possible to monitor how its temperature varies during the heating step. In some conditions, the transferred power not being modulable possibly submits the container to important thermal shocks and even causes its breakage. The device described in U.S. Pat. No. 5,208,896 A does not comprise circuits dedicated to supervising the accumulator and the heating elements nor to monitoring the electrical interconnections between the individual components, such as for instance the accumulator, the heating elements, and the temperature sensors.

### OBJECTS AND SUMMARY OF THE INVENTION

A first object of the present invention is thus to provide a transportable and self-heating food container that is simultaneously lightweight and little bulky.

A second object of the invention is to provide a container that is basically formed of two component parts, even purchasable separately, i.e. a low-cost part, comprising a container made from an electrically insulating material, preferably glass, which incorporates heating elements and sensors, and a higher-cost part, comprising a power and control unit, the latter being usable many times and such that, if coupled with different containers, it allows to perform a self-heating function without any need for having an electric power source available in that moment.

A further object of the invention is to implement a food container that is re-usable, hence easily washable and sterilizable.

A not least object of the present invention is to provide a food container that is capable of getting through all industrial processes necessary for both packaging and use, such as, for instance: sterilization, filling, closing, pasteurization, labelling, and packing.

A not less important object of the present invention is to provide a container featuring short heating times and whose batteries have a long duration.

This container is also re-usable and re-cyclable. Upon developing the inventive concept, a strong consideration was given to the increased cost of this novel container with respect to a common container as presently used.

The power and control part is implemented in a variety of forms, all of them being of reduced dimensions, with different power levels depending on the type of the container to be heated; usually the power and control part will be purchased separately. This component part, more expensive than the container, can be re-used several times and used on a variety of different types of containers, thanks to the fact that the accumulation element is rechargeable; further features, such as for example an interface to tablets or smartphones, can be added to this portion of the device according to the present invention, depending on the actual applications.

Other objects and advantages of the invention will be apparent to those skilled in the art upon reading the following text.

The above described objects are achieved with a food container comprising:
a vessel whose walls comprise at least one temperature sensor and heating groups formed of a plurality of thread-like and/or ribbon-like, elongate metal elements; for example, in the case of a glass container the heating elements might be implemented by using a ferrous alloy featuring a high content of nickel and chromium;
an electronic power and control module, comprising a rechargeable electric energy accumulator, functionally connected to said heating groups and to said temperature sensor.

As better detailed below, the electronic power and control module is capable of managing the energy accumulator in a very sophisticated manner, thanks to the fact that it comprises:
a microcontroller;
a power control circuit for controlling the transferred power;
a temperature measurement conditioning circuit, wherein temperature is assessed by a specifically developed sensor;
an energy accumulator management circuit, functionally placed in a position intermediate between the power source and the accumulator, which in turn comprises at least one integrated circuit, commonly referred to as chip, which interfaces the microcontroller;
an interface to which enables a user to exchange information with the microcontroller.

In one preferred embodiment, the heating groups have a coefficient of thermal expansion close to the coefficient of thermal expansion of the material that the container is made from and are preferably made from high performance metal alloys.

According to one advantageous and practical embodiment, the heating groups are incorporated in the thickness of the walls of the vessel. In the case of a glass vessel, the latter comprises threads or straps of a metal alloy, made from high performance ferrous alloys, featuring a high content of nickel and chromium; these alloys have special mechanical and electrical characteristics thanks to which the metal elements, besides having the capability of withstanding the very high temperatures that are typical of glass processing, have thermal expansion characteristics that are very similar to those of the material that the vessel is made from, i.e. they feature a coefficient of thermal expansion ranging from 2 to 10 μm/m° C., typically close to 8 μm/m° C.

This feature is necessary to prevent potential breakages, both during the production step, when the container is manufactured, and in all of the subsequent processes whereby the substance contained therein is treated, such as, for instance, container packaging and sterilization.

It is reported here that particularly good results were obtained by using alloys such as, for explanatory not limitative purposes only:
Nilo48®, i.e. a controlled-expansion nickel-iron alloy containing 48% of nickel, whose coefficient of thermal expansion was conceived so as to correspond to that of soft lead and soda-lime glass; this alloy also features a high inflection temperature.
Nilo® K, i.e. a nickel-iron-cobalt alloy featuring a controlled expansion, containing 29% of nickel. Its coefficient of expansion (which decreases as temperature increases up to the inflection temperature), corresponds to the speed of expansion of borosilicate glasses and of alumina ceramics.

The metal elements of the heating groups can be implemented according to different geometries and resistive values as a function of the shape of the vessel, the surface necessary for a good heat exchange, and as a function of the necessary power level to be used for heating the contents within the specified time delays.

Let's just remember, for example, that the following geometries can be used:
a single spiral wound about the walls;
a dual spiral, preferably used for the bottom of the container;
a heating coil arranged along a wall.

Heat is generated by Joule effect, by making a controlled pulsed current (or Pulse Wide Modulation or PWM current) flow through the metal elements; pulse width modulation is a type of digital modulation which allows to obtain an average voltage which varies as a function of the ratio of the duration of the positive pulse to that of the negative pulse, this ratio being called duty cycle. This solution allows to use rather small values of current, in the order of few Amperes; this is important in selecting the electrical contact elements which allow to establish a reversible coupling between the different component parts of the device.

In one particularly complete embodiment, the measurement conditioning circuit calculates the impedance of the heating groups, both in order to monitor the correct connection between the electronic power and control module and the vessel, and to identify the type of container that has been connected.

Advantageously the modulation of the power transferred from the energy accumulator to the heating elements takes place via a DC-DC converter of a converter-reducer-elevator type, an outstanding feature of which is in that it can output a voltage that is greater or lower than the battery's one.

In one particularly convenient and functional embodiment, the container according to the present patent application also comprises an air-tight lid, functionally associated with said vessel. The lid performs the primary function of hermetically closing the vessel that receives the food, thus allowing to transport food, including that featuring a high liquid component, safely and without leakages. In one particularly compact embodiment, the lid not only performs the function of hermetically closing the contents, but also that of providing the electrical connection between the elements present in the container: heaters, temperature sensor and others, being it possible to reversibly couple the power module with the lid itself.

### BRIEF DESCRIPTION OF THE DRAWINGS

FIGS. 1 thru 3 show some possible embodiments of the metal resistive elements: a spiral wound about the walls, a dual spiral, used for the bottom of the container, and a heating coil arranged along a wall.

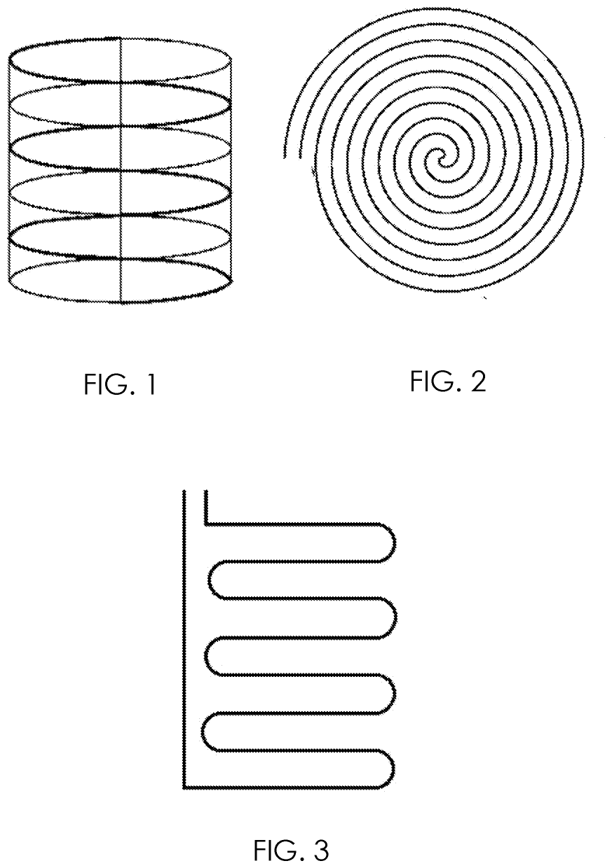

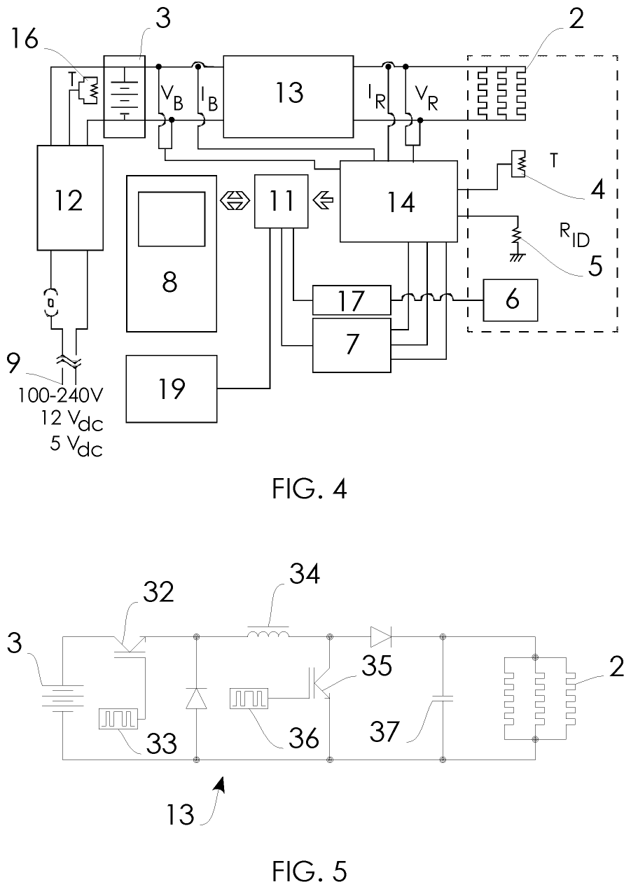

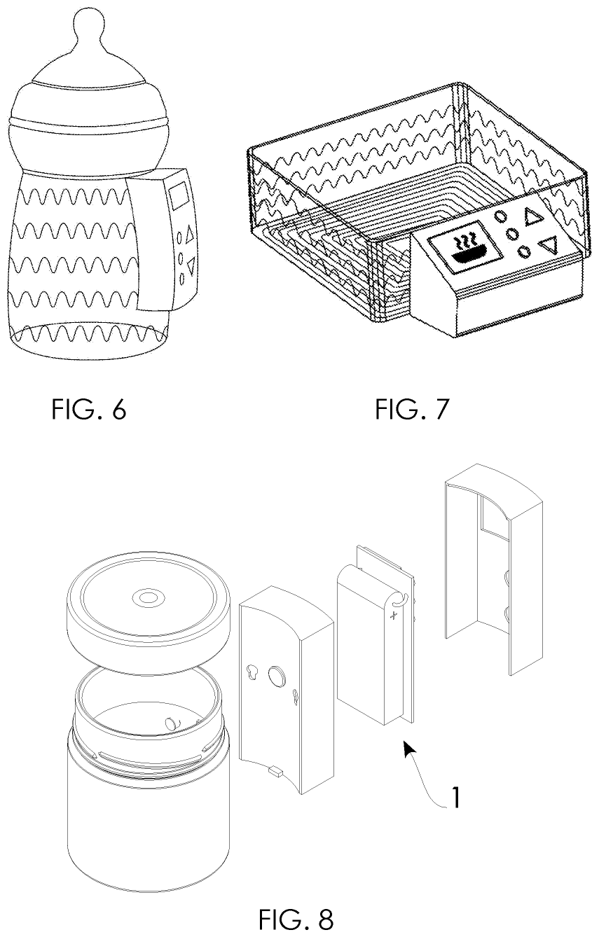

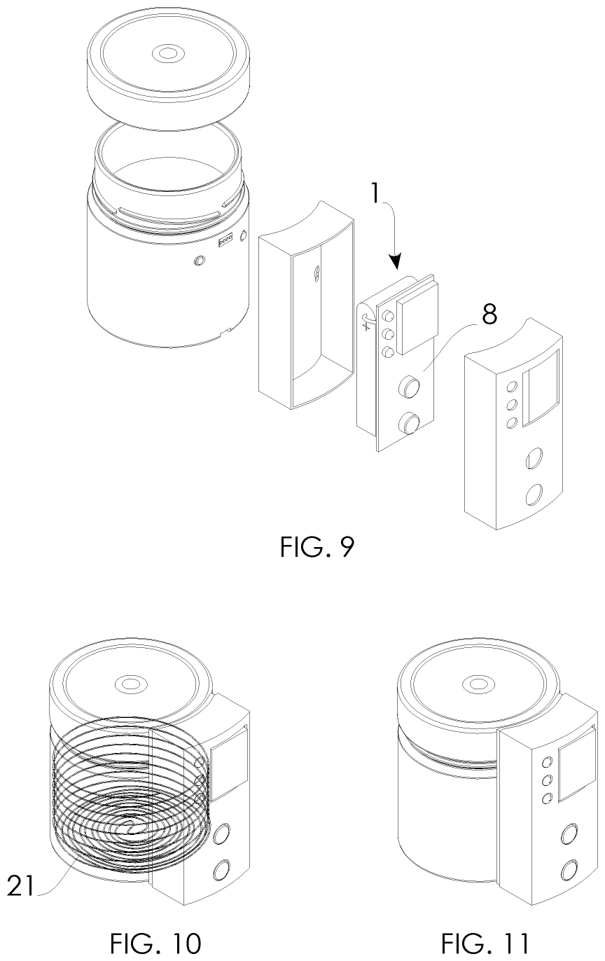

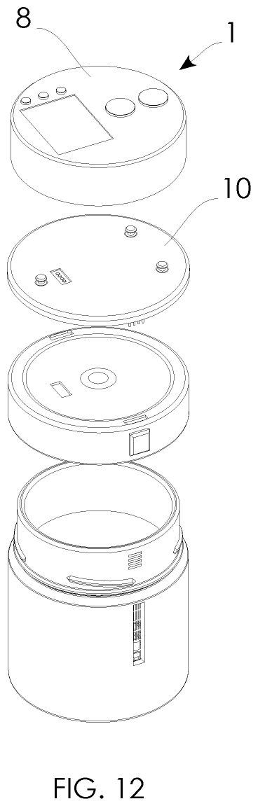

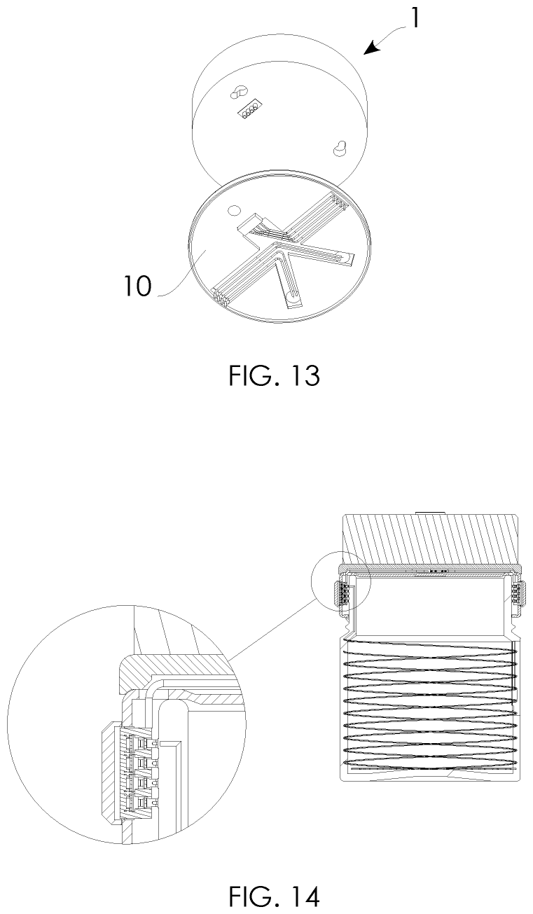

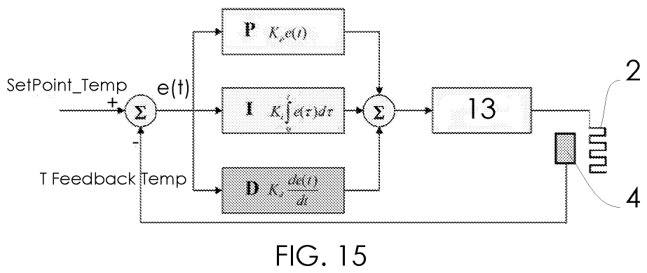

FIG. 4 shows a general block diagram of the electronic card of the power and control module (1). The following component parts are shown therein:
(11) a microcontroller;
(12) an energy accumulator management circuit;
(13) a transferred power regulator circuit;
(14) a measurement conditioning circuit;
(16) a rechargeable accumulator (£) temperature sensor;
(17) an EEPROM memory reader circuit;
(19) a Bluetooth® circuit.

The same figure also shows:
(2) heating elements;
(3) a connection for making it possible to reload the rechargeable electric energy accumulator (3) from an external source;
(4) a container temperature sensor;
(5) an identifying resistor;
(6) an EEPROM memory;
(7) an accelerometer;
(8) a user interface;
(9) an electric power source as necessary to recharge the energy accumulator (3).

FIG. 5 shows a circuit diagram of an electronic switch mounted in the power regulator circuit (13), which is controlled by the microcontroller via a proportional, integrative, derivative (PID) digital regulator. The figure shows:
(3) the rechargeable electric energy accumulator;
(32) a reducer stage electronic switch;
(33) a reducer stage electronic switch (32) drive;
(34) an inductor for the elevator and reducer stage function;
(35) an elevator stage electronic switch;
(36) an elevator stage electronic switch (35) drive;
(37) a smoothing capacitor;
(2) the heating elements.

FIG. 6 shows a further possible configuration of the invention shaped like a self-heating baby bottle.

FIG. 7 shows a further possible configuration of the invention shaped like a self-heating tray.

FIGS. 8 and 9 show two exploded views of a container with a power module laterally coupled therewith.

FIGS. 10 and 11 show two perspective, assembled views of a container with a power module laterally coupled therewith; FIG. 10 also shows the spirals of the metal elements (21) of the heating groups (2).

FIG. 12 shows an exploded view of a container wherein the power module is coupled via the lid. The electronic power module (1) can be coupled with the container via the lid, which an electrical interconnection disc (10) has been glued to, the latter providing the connections between the devices present in the walls of the container and the electronic power and control module (1). The connection between the power module (1) and the lid takes place reversibly via metal pivots and small pistons; the disc (10) along with the pivots is integrally connected to the lid underneath, whereas the cylinder positioned on the top forms the power module (1) with a user interface (8) integrated therewith on the top. The power module can be reversibly coupled with the assembly formed of the lid and the disc (10) along with the electrical connections.

FIG. 13 shows the underneath part of the power module (1), the disc (10) accommodating the electrical connections being integrally applied to the lid of the container.

FIG. 14 shows a cross-sectional view of a container wherein the power module is coupled with via the lid, as illustrated in FIG. 12, where a detail of the sliding contacts is shown in particular.

FIG. 15 shows a block diagram of a proportional, integrative, derivative (PID) digital controller; the functions performed by this controller are performed by the microcontroller (11), which interfaces to the container temperature sensor (4) and to the power regulator (13), which is in turn functionally connected to the heating elements (2).

The microcontroller (11) sets the temperature value to be reached, as a function of the required temperature/time, Celsius degrees/seconds thermal profile, via the Setpoint_Temp variable, and simultaneously measures the temperature reached in that moment, thus outputting the T feedback _Temp, temperature signal. An error variable, e(t), is generated on the basis of the difference between the set value and the measured value and processed by the power regulator to generate a duty duration D, i.e. the duration of the ON pulses to be applied to the electronic switch in order to increase or decrease the power transferred to the heating elements.

The power regulator thus allows to control the power transferred to the food in every instant and allows to continuously and precisely follow the desired temperature-time thermal profile by changing the temperature setpoint value.

During transfer of energy, the microcontroller (11) also controls the operating range and the conditions of the battery element in order for the process to take place regularly and ends either because it reaches the preset temperature or because the battery exhausts or an abnormality occurs.

### DETAILED DESCRIPTION OF ONE EMBODIMENT OF THE INVENTION

The electronic power and control module (1), besides supplying electric power, also modulates the duration of the voltage pulses across the metal elements (21), so as to proportionate the instant electric power as necessary to regulate the thermal power to be transferred to the walls of the vessel continuously and homogeneously, so as to obtain a controlled heating of its contents, according to preset thermal profiles.

The metal elements (21) of the heating groups (2) can be deposited or glued to the outside of the vessel, instead of being incorporated inside the walls of the container, the principle of operation of the device being unchanged; the distribution of the metal elements (21) can have different arrangements depending on the resistance values to be implemented and on the geometry of the vessel to heat.

According to one preferred embodiment, the walls of the vessel include appropriate spaces, preset during the moulding process, wherein at least one temperature sensor (4) is accommodated and interfaced to the power and control module (1); however, the temperature sensor might also be directly installed on the control device, so that the sensor gets in contact with the container whenever the control device is coupled with the container.

The temperature sensor (4), which is for instance a thermoresistor, precisely assesses the temperature of the wall of the container, by way of a special measurement conditioning circuit (14) in the electronic card, and communicates it to the microcontroller (11) in the electronic card of the power and control module (1), so that the latter can monitor the amount of heat that is transferred during the complete heating step, so as to accurately follow temperature/time thermal profiles; also, temperature assessing allows to prevent the container from reaching too high temperatures, which might spoil its contents and be harmful for users.

According to one particularly complete embodiment, an EEPROM memory (6), i.e. a non-volatile type of memory, as used in electronic devices for storing small amounts of data to be stored whenever electric power is switched off, might also be accommodated in the walls of the vessel. Data related to the food contained in the container, for example the name of the food producer, the packaging date, the expiration date, and the like, can be stored in this memory element. Also, if the EEPROM memory (6) is functionally connected to the power and control module (1), for example via a readout circuit (17) or directly via a built-in circuit present in the microcontroller (11), information might be easily stored therein, which might be taken advantage of during the heating step, such as for instance the thermal profile to be used, the maximum power level usable, the type of container, and the like.

The electronic power and control module (1) comprises at least a rechargeable electric energy accumulator (3) and an electronic control card, which in turn comprises a plurality of circuits and at least one microcontroller (11) which performs a supervisory function on all different operating steps of the device.

The electronic power and control module (1) possibly comprises a user interface (8), and the latter can comprise, in turn, a keyboard, possibly in a reduced-size format, with LEDs and/or a small display and/or other input/output devices of a known type.

According to a particularly advantageous embodiment, the rechargeable electric power accumulator (3) comprises one or several lithium cells connected in series and/or in parallel to each other.

Lithium cells provide very high discharge currents, which allow to supply extremely high powers levels within short times; however, these batteries are more complex to manage than dry batteries, nickel cadmium batteries or similar batteries, and consequently they need dedicated functions and electronic circuits in order for them to be managed in all steps of their service life.

The electronic control card of the power and control module (1) comprises at least the following different sections:
an energy accumulator (3) management circuit (12);
a transferred power control circuit (13);
a measurement conditioning circuit (14) with a connection control circuit integrated therein.

In one particularly performing embodiment of the invention, the control card also comprises one or more of the following further sections:
a user interface (8) control circuit, integrated in the user interface (8) or in the microcontroller (11);
an accelerometer (7) measurement circuit integrated in the microcontroller (11);
an EEPROM memory (6) readout circuit (17);
a Bluetooth® circuit (19).

The power and control module (1) is implemented in different power configurations as a function of the dimensions of the application, i.e., for example, as a function of the dimensions of the container and as a function of the required temperature gradient.

The energy accumulator (3) management circuit (12) is capable of analysing the conditions of the battery and evaluating the amount of charge stored, hence the residual energy available, on the basis of voltage, current, and temperature measurements; accumulator (3) temperature measurement can take place via a specifically developed sensor (16).

Also, the circuit (12) controls the charging step, account being taken of different important issues for a correct use of the battery, such as equalization of the voltages in the individual cells, amount of current drained, temperature, and charge calculation for determining when full autonomy is reached; also, the accumulator (3) management circuit (12) evaluates whether the accumulator (3) is efficient or not, and prevents it from being used in the case of abnormalities.

Low cost integrated control circuits, commonly referred to as chips, are by now present in the control integrated circuit market for this type of function, which perform all of the necessary functions and are capable of interfacing to the microcontroller (11); the latter supervises the energy accumulator (3) during the discharge step and stops it in the case of an abnormality or whenever the accumulator reaches the exhausted condition; as a matter of fact, cells shall not be discharged beyond a minimum voltage value, in order not to cause irreversible phenomena which would damage them.

The transferred power regulator circuit (13) allows to transfer electric power from the energy accumulator (3) to the heating groups (2). According to one particular advantageous solution, a DC-DC converter of a reducer-elevator converter type, also called “Buck-Boost converter”, is used, an outstanding characteristic of which is in that it can output a voltage greater or lower than that measured across the battery.

With reference to FIG. 5, let's note that, in this type of DC-DC converter, modulating the on and off statuses of the electronic switch (32) allows to get an output voltage Vout lower than the input battery voltage Vin, thus performing a reducer function; conversely, in this DC-DC converter, modulating the on and off statuses of the switch (35) allows to get an output voltage Vout greater than the input battery voltage Vin, thus performing an elevator function.

If these pulses are modulated at frequencies in the order of some kHz, the voltage is varied, and consequently the instant power applied to the heating elements can also be varied, thus controlling the container temperature.

The microcontroller (11) compares the desired temperature value to the value assessed by the temperature sensor (4) via the measurement conditioning circuit (14) and then generates an error function, e(t); the latter, via a proportional-integrative-derivative regulator, generates a duty cycle of the on-off pulses to be applied to the electronic switch in order to increase or decrease the power transferred to the heating elements.

The function performed by the measurement conditioning circuit (14) is to convert the analog quantities to be measured, such as voltages, currents, temperatures, and accelerations, within the range of voltage values accepted by the analog/digital converter present in the microcontroller (11), which is usually 0 to 3 V, in order to transform a physical quantity into a binary digital value subsequently used by the microcontroller for calculations and regulations.

The measurement conditioning circuit (14) is formed of operational amplifiers and resistors, so that, for example, the battery voltage, a value variable in a range from 10 to 30 V, is converted into a range from 0 to 3 V, or in such a way that a current or temperature is transformed into a voltage value in turn conforming to a dynamic range necessary to enable the microcontroller to perform a measurement accurately.

The power regulator circuit (13) thus allows to control the power transferred to the contents of the vessel in every instant and to continuously vary the desired temperature value so as to accurately follow the preset temperature/time thermal profile.

As far as energy is concerned, this type of modulation applies an average voltage to the heating elements which is lower than, equal to, or higher than the direct battery voltage, thus allowing to modulate the transferred power.

Simultaneously the microcontroller (11) controls the amount of energy drained by the accumulator (3) and the status thereof, via the energy accumulator (3) management circuit (12).

The measurement conditioning circuit (14) uses the analog/digital converter in the microcontroller (11) to transform a temperature sensor (4) resistance measurement into a very accurate digital temperature measurement.

The identifying resistor (5) readout circuit operates thanks to the fact that the microcontroller (11) sends a known, small intensity current to an identifying resistor (5) and assesses the voltage across the latter so that, a unique identifying resistor being associated with every type of container, the electronic power and control module (1) is capable of uniquely identifying the container that it has been connected to and determining the power necessary for heating.

The identification of the identifying resistor (5) mounted in the container also takes place via the analog/digital converter in the microcontroller (11); as a matter of fact, the resistance value of the resistor (5) is read via a resistive divider.

The connection control circuit is integrated in the measurement conditioning circuit (14) and takes advantage of the heating groups (2) impedance measurement to evaluate a correct interconnection between the different component parts of the container and their good operation, thanks to the analogue/digital converter in the microcontroller.

The connection control circuit can also assess, through an impedance measurement of the heating elements, for instance, a too high impedance, i.e. an open circuit, a circumstance that might mean a wrong connection between the individual components or a heating element being broken; should an impedance measurement give a too low value, i.e. a shorted circuit, it might mean, for instance, that a heating element is shorted.

Impedance measurement might also be taken advantage of for getting information on the container that the power element has been coupled with, especially if no memory elements are installed therein. As a matter of fact, lengths and shapes of the heating elements are implemented with different impedance values, as a function of the geometry and volumes of the container. Therefore, within certain intervals, the impedance value can be used to determine the type of the container, as shown for example in the following table, and to get rough information on the rower level to use.

| Container | Resistance | Max power |
|---|---|---|
| 300 ml | 12.5 ohms < R < 13.5 ohms | 30 W |
| 500 ml | 15 ohms < R < 18 ohms | 50 W |
| 750 ml | 20 ohms < R < 22 ohms | 75 W |

The temperature sensor might also detect abnormalities, upon making a measurement, should the measured values be too high or too low.

In a particularly advantageous construction, the EEPROM memory (6) readout circuit (17) can be connected to the microcontroller via a connection that uses one communication wire only, according to the so-called “1 wire” technology. The microcontroller might also put data stored in its own memory element available to a user via applications for portable processors, smartphones, and the like.

The user interface (8) management circuit can be integrated in the user interface or in the microcontroller (11), which is thus in a position to control a panel equipped with an LCD graphical display and/or signalling LEDs and/or buttons for accepting controls entered by a user.

If necessary, the power and control module also possibly comprises an accelerometer (7), i.e. a sensor capable of taking a measurement of displacements and their respective accelerations. This type of sensor might be extremely worth for understand whether a container is stirred or not during a heating step, so as to improve heat distribution inside the contained food, especially when this is a liquid one.

The measurement conditioning circuit (14) also allows to pick-up the acceleration signals coming from the analog outputs of the accelerometer (7), conditioning them in a range from 0 to 3 V of the analog/digital converter present in the microcontroller (11), thus making it possible to measure accelerations along the three Cartesian axes X, Y, Z.

Two solutions were worked out in embodying the invention, the former consisting of coupling the power device directly on the walls of the container, whereas in the other solution coupling takes place through the lid.

In the latter case, the lid also performs the function of interconnecting the different electric and electronic parts: heating elements, sensors, and electronic power module, besides performing the function of sealing the contents. In order to enable the lid to also perform the function of interconnecting the different electric parts, sliding connectors are used which allow to perform the electric connections between the lid and the container so that the jar can be opened and subsequently closed again. A characteristic of these connectors is in that they can handle the high currents necessary for the subject application.

The power circuit (13) contained in the power module which controls the power supplied to the heating elements (2) is connected to the lid and from this to the heating elements via slots which engage projecting pivots; besides providing an optimum electrical connection, capable of carrying currents of some Amperes, this type of connection also provides a strong mechanical connection, as necessary between the individual component parts for the heating function; slots and pivots are preferably made from metal materials.

The connection of the sensors is made via a small-piston connector. Both these couplings are of a reversible type and allow to use the electronic power module several times and on several jars.

The electronic control circuit (1) optionally allows to also install a Bluetooth® controller (19), which allows to transfer all information of the power module to an ad hoc application via a smartphone or a computer.

1-14. (canceled)

15. A self-heating container for food comprising:
a vessel made from an electrically insulating material comprising one or more walls that are functionally connected to at least one temperature sensor and incorporate heating groups comprising a plurality of thread-like, ribbon-like or a combination of thread-like and ribbon-like elongate metal elements; and
an electronic power and control module, functionally connected to said heating groups and comprising a rechargeable energy accumulator comprising one or several high-performance cells;
wherein said elongate metal elements are heated by Joule effect, causing a pulsed current supplied by said rechargeable energy accumulator and controlled by said electronic power and control module to flow through the elongate metal elements, the latter comprising:
a microcontroller;
a power control circuit for controlling power transferred from the rechargeable energy accumulator to the elongate metal elements;
a measurement conditioning circuit which transfers a temperature value assessed by said at least one temperature sensor to said microcontroller;
an energy accumulator management circuit for controlling the rechargeable energy accumulator, which an energy accumulator management circuit comprises at least one integrated circuit, electronically interfaced to said microcontroller and electrically connected between a power source and said rechargeable energy accumulator; and
a user interface for exchanging information with said microcontroller.

16. The container according to claim 15 wherein said elongate metal elements comprise a coefficient of thermal expansion, wherein the coefficient of thermal expansion of the elongate metal elements is the same as the coefficient of expansion of the material that said vessel is made from.

17. The container according to claim 15 wherein said vessel is made from glass.

18. The container according to claim 16 wherein said vessel is made from glass

19. The container according to claim 18 wherein the coefficient of thermal expansion of said elongate metal elements ranges from 2 to 10 μm/m° C.

20. The container according to claim 19 wherein said coefficient of thermal expansion of said elongate metal elements equals 8 μm/m° C.

21. The container according to claim 15 wherein the heating groups comprise an impedance, wherein further said measurement conditioning circuit measures the impedance of said heating groups.

22. The container according to claim 15 wherein a lid is functionally associated with said vessel, such lid operating, via sliding contacts, as an intermediary for an electrical interconnection between the heating groups, the temperature sensor and the electronic power and control module, thus implementing a reversible, on or off, plug-in coupling.

23. The container according to claim 22 wherein said lid comprises spring small pistons.

24. The container according to claim 15 wherein an identifying resistor, having a predetermined value as a function of the type of container, is associated therewith, and wherein said identifying resistor is electrically connected to the electronic power and control module which identifying resistor is capable of determining its value by measuring the voltage drop that is created across it by way of a resistive divider.

25. The container according to claim 24 wherein a lid is functionally associated with said vessel, such lid operating, via sliding contacts as an intermediary for an electrical interconnection between the heating groups, the temperature sensor, the identifying resistor and the electronic power and control module, thus implementing a reversible, on or off, plug-in coupling

26. The container according to claim 15 comprising an accelerometer functionally connected to said microcontroller.

27. The container according to claim 15 wherein said power control circuit comprises a DC-DC converter of a reducer-elevator type.

28. The container according to claim 27 wherein said DC-DC converter comprises a proportional-integrative-derivative (PID) regulator and a pulse width modulator (PWM).

29. The container according to claim 28 comprising an EEPROM memory and wherein the card of the electronic power and control module comprises a circuit built according to the “1 wire” technology for reading out said EEPROM memory.

30. The container according to claim 29 wherein a lid is functionally associated with said vessel, such lid operating, via sliding contacts as an intermediary for an electrical interconnection between the heating groups, the temperature sensor, the EEPROM memory and the electronic power and control module, thus implementing a reversible, on or off, plug-in coupling.

31. The container according to claim 15 comprising an electronic Bluetooth® module interfacing to said microcontroller.

32. A self-heating container for food comprising:
a vessel made from an electrically insulating material comprising one or more walls that are functionally connected to at least one temperature sensor and incorporate heating groups comprising a plurality of thread-like, ribbon-like or a combination of thread-like and ribbon-like elongate metal elements, wherein said elongate metal elements comprise a coefficient of thermal expansion, wherein the coefficient of thermal expansion of the elongate metal elements is the same as the coefficient of expansion of the material that said vessel is made from, wherein the heating groups comprise an impedance;
an electronic power and control module, functionally connected to said heating groups and comprising a rechargeable energy accumulator of a type with one or several high-performance cells;
wherein said elongate metal elements are heated by Joule effect, causing a pulsed current supplied by said rechargeable energy accumulator and controlled by said electronic power and control module to flow through the elongate metal elements, the latter comprising:
a microcontroller;
a power control circuit for controlling power transferred from the rechargeable energy accumulator to the elongate metal elements;
a measurement conditioning circuit which transfers a temperature value assessed by said at least one temperature sensor to said microcontroller and measures the impedance of said heating groups;
an energy accumulator management circuit for controlling the rechargeable energy accumulator, wherein the energy accumulator management circuit comprises at least one integrated circuit, electronically interfaced to said microcontroller and electrically connected between a power source and said rechargeable energy accumulator;
a user interface for exchanging information with said microcontroller;
wherein a lid is functionally associated with said vessel, such lid operating, via sliding contacts as an intermediary for an electrical interconnection between the heating groups, the temperature sensor and the electronic power and control module, thus implementing a reversible, on or off, plug-in coupling.

33. A self-heating container for food comprising:
a vessel made from an electrically insulating material comprising one or more walls that are functionally connected to at least one temperature sensor and incorporate heating groups comprising a plurality of thread-like, ribbon-like or a combination of thread-like and ribbon-like elongate metal elements, wherein said elongate metal elements comprise a coefficient of thermal expansion, wherein the coefficient of thermal expansion of the elongate metal elements is the same as the coefficient of expansion of the material that said vessel is made from;
an electronic power and control module, functionally connected to said heating groups and comprising a rechargeable energy accumulator of a type with one or several high-performance cells;
an identifying resistor, having a predetermined value as a function of the type of container, which identifying resistor is electrically connected to the electronic power and control module, wherein the identifying resistor is capable of determining its value by measuring the voltage drop that is created across it by way of a resistive divider;
wherein said elongate metal elements are heated by Joule effect, causing a pulsed current supplied by said rechargeable energy accumulator and controlled by said electronic power and control module to flow through the elongate metal elements, the latter comprising:
a power control circuit for controlling power transferred from the rechargeable energy accumulator to the elongate metal elements;
a measurement conditioning circuit which transfers a temperature value assessed by said at least one temperature sensor to said microcontroller;
an energy accumulator management circuit for controlling the rechargeable energy accumulator, which energy accumulator management circuit comprises at least one integrated circuit, electronically interfaced to said microcontroller and electrically connected between a power source and said rechargeable energy accumulator;
a user interface for exchanging information with said microcontroller;
wherein a lid is functionally associated with said vessel, such lid operating, via sliding contacts as an intermediary for an electrical interconnection between the heating groups, the temperature sensor, the identifying resistor and the electronic power and control module, thus implementing a reversible, on or off, plug-in coupling.

34. The container according to claim 32 wherein said vessel is made from glass.
